(19) United States
(12) Patent Application Publication
(10) Pub. No.: US 2002/0097470 A1
(43) Pub. Date: Jul. 25, 2002

(54) Process for improving the signal quality of optical signals, transmission system and modulator

(75) Inventors: Berthold Wedding, Korntal-Munchingen (DE); Christoph Haslach, Stuttgart (DE); Stefan Herbst, Elze (DE)

Correspondence Address: SUGHRUE MION, PLLC, 2100 Pennsylvania Avenue, NW, Washington, DC, 20037-3213, US

(73) Assignee: ALCATEL

(21) Appl. No.: 09/989,457

(22) Filed: Nov. 21, 2001

(30) Foreign Application Priority Data
Nov. 23, 2000 (DE) 100 58 255.9

(51) Int. Cl. H04J 14/02; H04B 10/00

(52) U.S. Cl. 359/156; 359/124

(57) ABSTRACT

A process for improving the signal quality of optical signals, a transmission system for the transmission of optical signals, and a modulator for DGD are proposed. Transmission system, transmitter and process operate with a DGD- and a polarisation modulator which modulates the optical signal at the transmitter end.

### BACKGROUND OF THE INVENTION

The invention is based on a priority application DE 100 58 255.9 which is hereby incorporated by reference.

A process for improving the signal quality of optical signals, a transmission system for transmitting optical signals and a modulator are proposed.

For the optical transmission of high-bit-rate signals, where data rates of 10 Gbit/s to 40 Gbit/s are concerned, limitations caused by physical properties of the transmission fibres are observed. Problems due to attenuation and chromatic dispersion are overcome by the use of fibre amplifiers of dispersion-shifted fibres and dispersion compensation techniques. However, even when monomode fibres are used, the polarisation mode dispersion (PMD) effect remains as a limiting effect on the fibre length and data rate. PMD has a birefringence effect which primarily leads to a propagation of the signal on two different paths and thus to a signal distortion.

One parameter for describing the distortions due to PMD are relative powers γ and 1−γ of the signal which are associated with the fast and slow main axes of the birefringent fibres. The second parameter is the differential delay between the group velocities (DGD=differential group delay) Δτ.

Distortion due to PMD is of a statistical nature and changes over time. In particular, different environmental temperatures lead to a fluctuation in the PMD. To obtain analyzable signals in spite of these dispersion effects, many different types of PMD compensation or filtering are used in receivers for optical signals. For example, the survey article “Equalization of Bit Distortion Induced by Polarization Mode Dispersion” by H. Bülow, NOC 97, Antwerp, p. 65 to 72 describes several possibilities whereby polarisation mode dispersion can be corrected. One possibility of solving the problems associated with polarisation mode dispersion consists of operating a polarisation controller in the receiver and adaptively matching the polarisation of the optical signal to the polarisation dispersion of the transmission link. The information relating to the polarisation dispersion of the transmission link is provided via a reverse channel. Polarisation control of this kind is costly and must be separately implemented for each optical signal of a wavelength. This is especially problematic when the optical signal is a signal composed of a wavelength division multiplex. Especially in high-bit-rate data transmission systems, the signals often consist of different wavelength signals. This WDM (wavelength division multiplex) process facilitates the transmission of data transmitted on a number of modulated optical carriers whose frequencies differ. Especially in a case of this kind, in which a plurality of lasers operating independently of one another operate in parallel as sources of the optical signal, active adaptation of the polarisation plane of the individual signals is no longer possible.

### SUMMARY OF THE INVENTION

In comparison, the process and transmission system according to the invention have the advantage that no active adaptation of the transmission system to the problems of the polarisation mode dispersion takes place, but the effects of the polarisation mode dispersion are statistically distributed by modulation of the polarisation plane—thus modulation in γ—and modulation of the DGD—thus in Δτ—such that—averaged over all the optical signals to be transmitted at an arbitrary transmission wavelength—an improved transmission characteristic can be obtained. It is advantageous that, if the transmission system has very high bit error rates in a specific polarisation state and with a specific DGD of the signal, it is pulled out of this state by the modulation. On the other hand, the system can possess polarisation states in which the system operates virtually error-free. As a result of the modulation, the system is prevented from remaining in a very negative transmission state, while the time during which it remains in a positive transmission state is also limited. The modulation results in an improved statistical distribution of positive and negative transmission characteristics of the optical signal viewed over time.

It is also advantageous to employ a FEC process (forward error correction) in the transmission system. The FEC process reduces the bit error rate in WDM transmission systems in that redundant information, such as for example individual code bits, are added to the information of the individual optical channels. At the receiver end a decoder investigates the code bits in order to be able to exactly reconstruct the transmitted information. A plurality of different algorithms are known, such as Viterbi algorithms, Reed-Solomon.

Particularly advantageous transmission values can be obtained specifically with the combination of the bit error rates temporarily occurring due to the modulation with a FEC algorithm. The modulation of the polarisation state and of the DGD of the optical signal advantageously take place with a frequency which is lower than the bit rate but is in the region of the FEC frame frequency. To further improve the transmission system and the process, PMD equalizers which can follow the frequency of the modulation should be used in the receiver.

Modulators for modulating polarisation γ and DGD Δτ are known from U.S. Pat. No. 5,930,414 which proposes an optical compensator which recovers the transmitted signal in the receiver by adapting the polarisation and the DGD. Here a polarisation modulator based on a Mach-Zehnder structure is used and the DGD is temporally adapted.

### BRIEF DESCRIPTION OF THE DRAWINGS

A possible embodiment of the invention is described in the drawings and will be explained in detail in the following description.

In the drawing:

FIG. 1 illustrates a WDM transmission system,

FIG. 2 illustrates a DGD modulator,

FIG. 3 illustrates another embodiment of a DGD modulator,

FIG. 4 illustrates a second exemplary embodiment for a WDM transmission system at the transmitter end,

FIG. 5 illustrates a third exemplary embodiment for a WDM transmission system at the transmitter end.

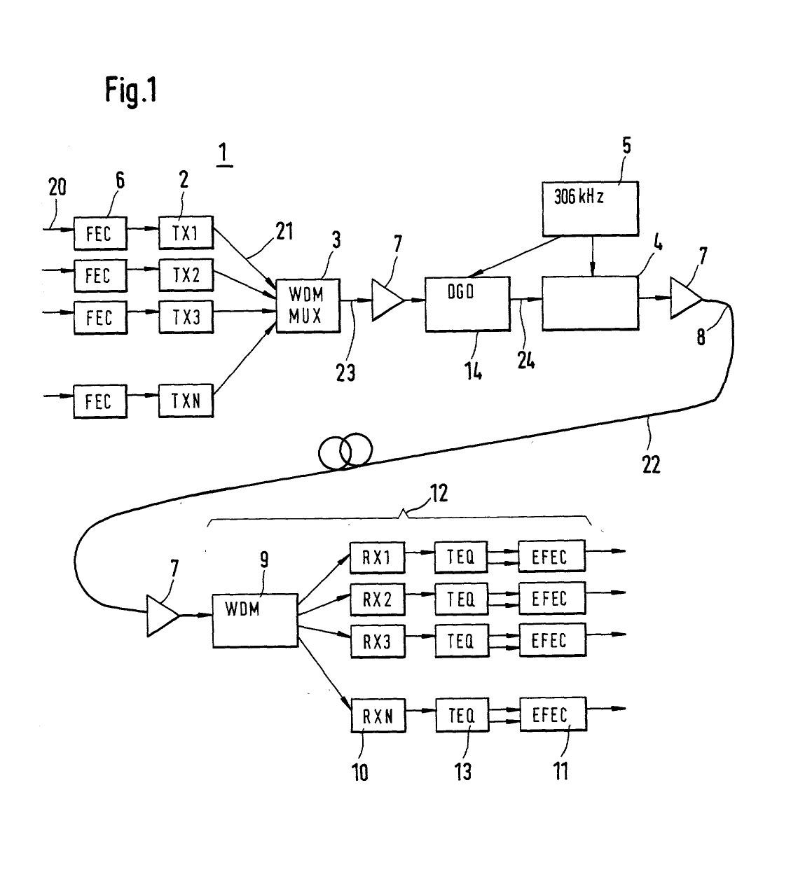

FIG. 1 shows a complete transmission system for optical signals. A transmitter 1 is connected to a transmission link 8. The transmission link 8 terminates at a receiver 12. The electrical input signal is firstly applied to a FEC unit 6. The electrical signal at the output of the FEC unit 6 is applied to the input of the electro-optical converter 2. The output of the electro-optical converter 2 is connected to the input of the wavelength division multiplexer 3. In this exemplary embodiment the output of the wavelength division multiplexer is connected to an amplifier 7. The amplifier is in turn connected firstly to a DGD modulator 14 and then to a polarisation modulator 4 and another amplifier 7. The DGD modulator 14 and the polarisation modulator 4 are connected to a generator 5 for the modulation frequency. The signal of the amplifier 7 passes across the transmission link 8. The signal is applied to the input of a receiver 12. In this case an amplifier 7 is again the first input stage. The output of the amplifier 7 is connected to a wavelength division demultiplexer 9 whose outputs are each connected to a respective input of an opto-electric converter 10. The outputs of the opto-electric converters 10 are connected to FEC regenerators 11. For the transmission of the optical signals in such a transmission system, the polarisation of the optical signal, for example of a 10 Gbit/s signal, is modulated with a high frequency. The modulation frequency amounts for example to 306 kHz. A transmission system with polarisation mode dispersion can prove particularly susceptible to faults under certain conditions. For example, a situation can occur in which the differential group delay amounts to exactly one bit period and the power in the two modes orthogonally polarised to one another is equal. In these cases even the use of a FEC process cannot ensure good results in the recovery of the signal. The system is “modulated out” of such a state by the modulation of the polarisation. The polarisation of the optical signal is modulated with a specific frequency. This frequency is to be sufficiently high to permit the correction of the bit errors with a FEC process. Due to the modulation and the averaging over the polarisation mode dispersion, bit error rates occur in a short time scale. The resultant bit error rate can then be further reduced by a FEC process. As a result of the averaging effect, the response of the transmission system is improved compared to an unmodulated system.

A further improvement is achieved by the use of a PMD equalizer in the receiver 12. This filter has the form of an electronic filter 13, as described for example in German Application 199 36 254.8 or German Application 100 13 790.3. The electronic equalizer 13 is shown by way of example outside the opto-electric converter 10. In another embodiment the equalizer is integrated into the opto-electric converter itself. When an electronic PMD filter is used, it should be ensured that the reaction time of the filter is sufficiently fast to follow the modulation of the polarisation.

In another embodiment, an optical PMD filter is used in the receiver 12 prior to the opto-electric conversion. Another embodiment firstly employs an optical PMD filter in the receiver 12 prior to the conversion of the optical signal and an electronic PMD equalizer following the conversion.

A further improvement is achieved by the use of an error-and-erasure algorithm. This known algorithm combined with a fast filter 13 enables the length of an error burst to be doubled and increases the PMD tolerance of the optical receiver. An embodiment of the transversal equalizer according to DE 199936254.8 or DE 100 13 790.3 can be used for example as filter 13. This filter supplies information for the use of the error-and-erasure method derived from the control parameters of the filter 13. The filter must supply information about the location of the error in the signal in order to support the following stage of the error-and-erasure processing of the signal.

The electrical signal 20 present at the input end is converted into an optical signal 21 in the electro-optical converter 2. This optical signal 21 has a specific polarization state. The electro-optical converter has the form of a laser diode which is either directly modulated or whose light passes through an external modulator.

A transmitter in the embodiment according to FIG. 1 serves for use in a wavelength division multiplex. A plurality of electro-optical converters 2 are used. These electro-optical converters 2 convert electrical input signals 20 into optical signals 21 of different wavelengths. The optical input signals are applied to a wavelength division multiplexer 3. The output signal 23 of the wavelength division multiplexer 3 contains all the information of the different wavelength channels. This signal, which contains different polarisation states of the different electro-optical converters 2, is then modulated in its parameter Δτ in a DGD modulator 14 and is modulated in its polarisation states γ in the polarisation modulator 4. The modulated optical signal 22 is fed to the transmission link. Especially for a wavelength division multiplex transmission process of this kind, it is important that the system should not remain in a polarisation state for a channel in which high bit error rates are generated. In some cases this leads to a total failure of a wavelength channel. As a result of the modulation, this channel is brought into polarisation states whose transmission properties lead to distinct improvements of the bit error rates.

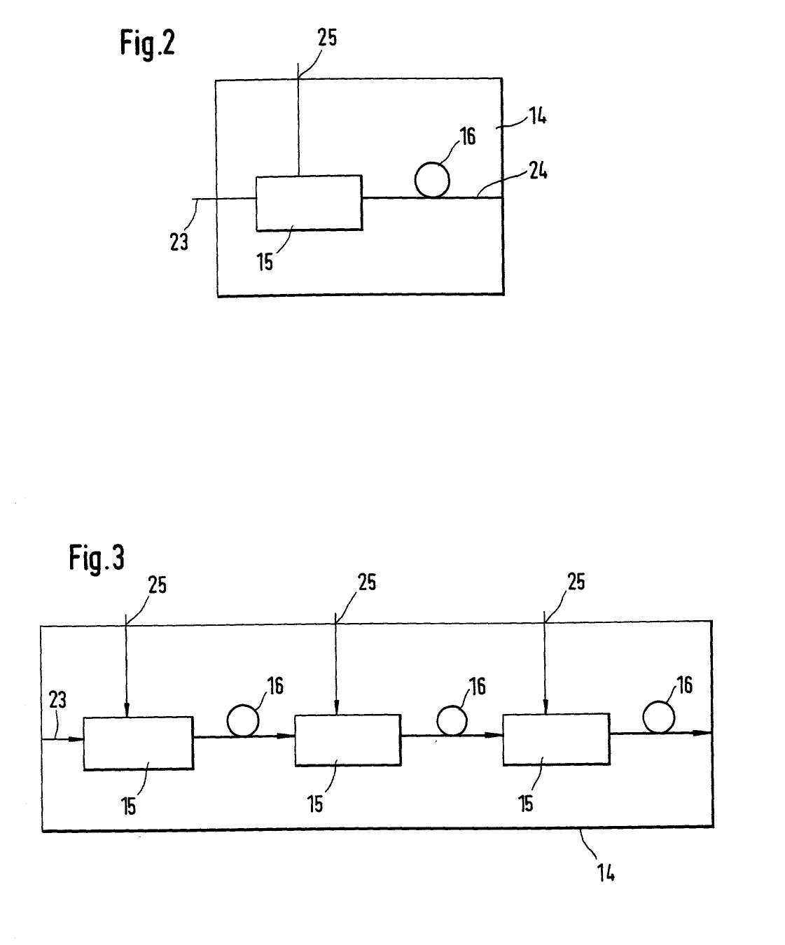

FIG. 2 illustrates an example of the construction of a DGD modulator 14. It contains a polarisation modulator 15 which is connected to a fibre section 16 consisting of a fibre with a high degree of birefringence. The WDM-multiplexed signal 23 is fed in at the input end. The polarisation modulator changes the polarisation planes of the signals as a function of the original polarisation state. The electrical signal 25 of the generator 5 is applied to the polarisation modulator 15. The signal passes through the fibre section 16 and thereby experiences a different DGD depending upon the polarisation state. The thus DGD-modulated signal 24 issues from the DGD modulator 14. The entire modulator 14 is connected to the polarisation modulator 4.

FIG. 3 illustrates a construction corresponding to FIG. 2 in which three individual DGD-modulators are connected in series. The individual components each contain fibre sections 16 with different birefringence. In this way an even greater change in the signal relative to the state of the DGD is obtained.

The described examples do not constitute a limitation of the design of the DGD modulator. Other components, such as liquid crystal components, lithium niobate modulators, mixers etc., can be used.

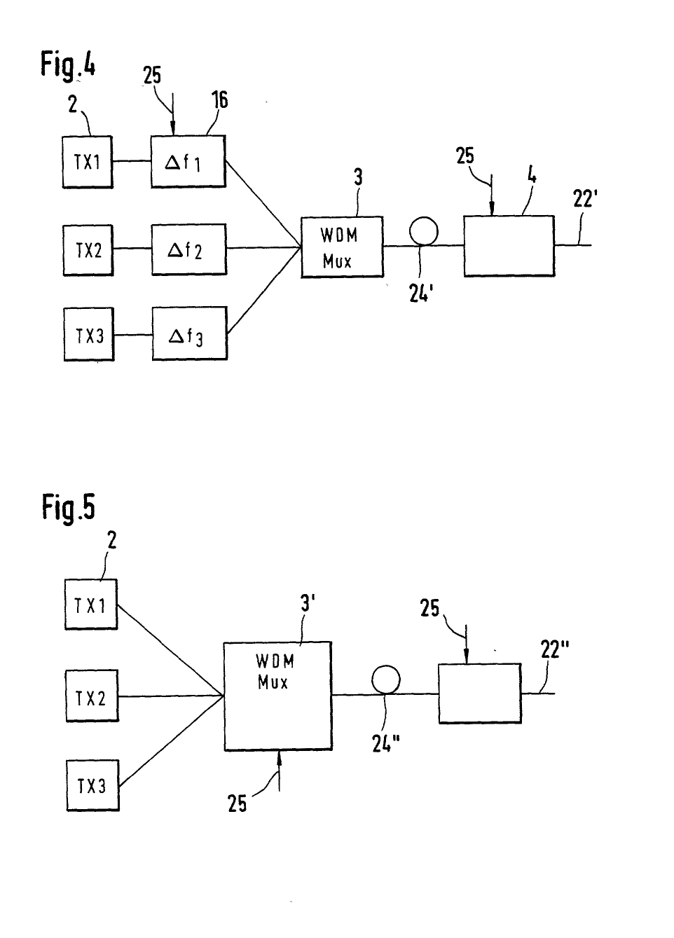

Frequency hopping represents another possibility of DGD modulation. FIG. 4 illustrates the transmitter end of a WDM transmission system. The electro-optical converters 2 are connected to a frequency mixer 16 and only then to the WDM multiplexer 3. The signal modulated with the information to be transmitted is additionally modulated in frequency with a frequency below the bit rate. As a result of the transmission on the normal monomode fibre the resultant signal 24′ experiences a different DGD depending upon the frequency of the signal 24′. The frequency-modulated signal is additionally modulated in its polarisation state in the polarisation modulator 4 and transmitted as signal 22′. The other components of the transmission system have not been shown in the Figure.

FIG. 5 illustrates another possibility of frequency hopping. The electro-optical converters 2 are connected to a modified WDM multiplexer 3′. The latter additionally contains the function of scrambling the information of the individual optical channels. In this way bit sequences are distributed between different frequencies. Also in this embodiment the signals 24″ experience different DGD values on the transmission link.

Adaptation of the individual components is necessary for the construction of a transmission system. The form described in FIG. 1 and FIG. 4 constitutes an exemplary implementation which does not require the presence of a specific combination of components for the application of the principle according to the invention.

1. A transmission system for transmitting optical WDM-signals via transmission links with transmitters and receivers, wherein at the transmitter end a coding takes place with a FEC which is decoded at the receiver end, characterised in that at the transmitter end the optical signal passes through a polarisation modulator and a DGD (differential group delay) modulator for the modulation of the signal.

2. A transmission system according to claim 1, wherein the receiver comprises filters for the compensation of PMD effects.

3. A modulator for modulating an optical signal in a WDM transmission system consisting of a polarisation modulator and a DGD modulator which are connected to a generator with a fixedly adjustable frequency, where the frequency of the generator is defined by the error correction process.

4. A modulator according to claim 3, installed at the transmitter end.

5. A modulator according to claim 3, installed in the transmission link.

6. A modulator according to claim 3, connected to at least one further modulator.

7. A DGD modulator consisting of a polarisation modulator and a fibre section composed of a fibre with a high degree of birefringence which is connected to a generator with a fixedly adjustable frequency, where the frequency of the generator is defined by the error correction process.

8. A DGD modulator consisting of a frequency mixer and a transmission fibre with normal birefringence, where the frequency mixer is connected to a generator with a fixedly adjustable frequency, and the frequency of the generator is defined by the error correction process.

9. A process for improving the signal quality of optical signals which are distorted as a result of polarisation mode dispersion, wherein the optical signal is varied in its polarisation direction and its DGD.

10. A process according to claim 9, wherein the optical signal additionally is periodically varied in its polarisation direction, the frequency of the variation being dependent upon the error correction process which is used.

11. A receiver for use in a transmission system according to claim 1, wherein the receiver contains demultiplexers, optical receivers, filters and FEC regenerators.

12. A receiver according to claim 11, wherein error-and-erasure regenerators are connected to linear equalizers.

13. A receiver according to claim 11, wherein the electronic filter at least follows the frequency of the polarisation changes of the modulators.
